(19) United States
(12) Patent Application Publication
(10) Pub. No.: US 2026/0349906 A1
(43) Pub. Date: Nov. 5, 2026

(54) METHOD, DEVICE, AND COMPUTER PROGRAM PRODUCT FOR UPDATING TEST CASE LIBRARY

(71) Applicant: Dell Products L.P., Round Rock, TX (US)

(72) Inventors: Tianyu Ma, Shanghai (CN); Shirley Li Xie, Shanghai (CN)

(21) Appl. No.: 19/220,699

(22) Filed: May 28, 2025

(30) Foreign Application Priority Data
Apr. 30, 2025 (CN) 202510571272.5

(51) Int. Cl. G06F 11/3668

(52) U.S. Cl. CPC G06F 11/368

(57) ABSTRACT

A method for updating a test case library in an illustrative embodiment includes acquiring a candidate test case; and extracting, by means of a language model, a feature representation of the candidate test case. The method also includes determining a similarity between the feature representation of the candidate test case and one or more feature representations in a feature representation library corresponding to the test case library. The method further includes adding the candidate test case to the test case library in response to the similarity meeting a predetermined condition. In this way, candidate test cases with low similarity to existing test cases can be quickly filtered out and added to the test case library, thereby improving the diversity of test cases and enhancing testing efficiency.

### RELATED APPLICATION

The present application claims priority to Chinese Patent Application No. 202510571272.5, filed Apr. 30, 2025, and entitled “Method, Device, and Computer Program Product for Updating Test Case Library,” which is incorporated by reference herein in its entirety.

### FIELD

The present disclosure relates to the field of software and, more particularly, to a method, a device, and a computer program product for updating a test case library.

### BACKGROUND

A test case library is a database or collection of tools used to store, manage, and maintain test cases. It is the core asset in a software testing process, which can help testing teams efficiently execute tests, reuse test cases, and track test results. By increasing the diversity of the test cases, potential defects can be more comprehensively discovered, testing blind spots can be reduced, and software testing coverage and efficiency can be ensured.

Fuzzy testing runs the program through seed input, performs mutation on the seed input to improve branch coverage, and performs loop execution of input mutation and the running process of the target program. This technology can be used in practical scenarios such as web browsers and databases.

### SUMMARY

In a first aspect of embodiments of the present disclosure, a method for updating a test case library is provided. The method includes acquiring a candidate test case; extracting, by means of a language model, a feature representation of the candidate test case; determining a similarity between the feature representation of the candidate test case and one or more feature representations in a feature representation library corresponding to the test case library; and adding the candidate test case to the test case library in response to the similarity meeting a predetermined condition.

In a second aspect of embodiments of the present disclosure, an electronic device is provided. The electronic device includes at least one processor, and memory coupled to the at least one processor and having instructions stored therein, wherein the instructions, when executed by the at least one processor, cause the electronic device to perform actions. The actions comprise acquiring a candidate test case; extracting, by means of a language model, a feature representation of the candidate test case; determining a similarity between the feature representation of the candidate test case and one or more feature representations in a feature representation library corresponding to a test case library; and adding the candidate test case to the test case library in response to the similarity meeting a predetermined condition.

In a third aspect of embodiments of the present disclosure, a computer program product is provided. The computer program product comprises a non-transitory computer-readable medium having machine-executable instructions stored therein, wherein the machine-executable instructions, when executed by a machine, cause the machine to perform actions. The actions comprise acquiring a candidate test case; extracting, by means of a language model, a feature representation of the candidate test case; determining a similarity between the feature representation of the candidate test case and one or more feature representations in a feature representation library corresponding to a test case library; and adding the candidate test case to the test case library in response to the similarity meeting a predetermined condition.

It should be understood that the content described in this Summary is neither intended to limit key or essential features of embodiments of the present disclosure, nor intended to limit the scope of the present disclosure. Other features of the present disclosure will become readily understood from the following description.

### BRIEF DESCRIPTION OF THE DRAWINGS

The above-mentioned and other features, advantages, and aspects of embodiments of the present disclosure will become more apparent with reference to the accompanying drawings and the following Detailed Description. In the accompanying drawings, identical or similar reference numerals represent identical or similar elements, in which:

FIG. 1 shows a schematic diagram of an example environment in which a plurality of embodiments of the present disclosure can be implemented;

FIG. 2 shows a flow chart of a method for updating a test case library based on a language model according to some embodiments of the present disclosure;

FIG. 3 shows a flow chart of a method for determining whether to add candidate test cases to a test case library according to some embodiments of the present disclosure;

FIG. 4 shows a flow chart of a preprocessing method according to some embodiments of the present disclosure;

FIG. 5 shows a flow chart of a method for updating a seed corpus of fuzzy testing according to some embodiments of the present disclosure;

FIG. 6 shows a schematic diagram of a mutation method for a fuzzy test seed; and

FIG. 7 shows a block diagram of a device that can implement a plurality of embodiments of the present disclosure.

### DETAILED DESCRIPTION

Illustrative embodiments of the present disclosure will be described in more detail below with reference to the accompanying drawings. Although some embodiments of the present disclosure are illustrated in the accompanying drawings, it should be understood that the present disclosure may be implemented in various forms and should not be construed as being limited to the embodiments set forth herein. Rather, these embodiments are provided for a more thorough and complete understanding of the present disclosure. It should be understood that the accompanying drawings and embodiments of the present disclosure are for illustrative purposes only, and are not intended to limit the scope of protection of the present disclosure.

In the description of embodiments of the present disclosure, the term “include” and similar terms thereof should be understood as open-ended inclusion, i.e., “including but not limited to.” The term “based on” should be understood as “based at least in part on.” The term “an embodiment” or “the embodiment” should be construed as “at least one embodiment.” The terms “first,” “second,” and the like may refer to different or the same objects. Other explicit and implicit definitions may also be included below.

In software testing tasks such as application programming interface (API) testing, a large number of configurable parameters are often involved, such as file paths, file names, permissions, etc. Software testing needs to comprehensively cover a variety of scenarios: including situations where parameter formats are correct, parameter values exceed a valid range, and parameter formats are incorrect. In addition, parameter combination testing is also indispensable, because some defects will only appear under specific parameter combinations. For example, an abnormality will be triggered only when parameter A and parameter B are set at the same time. In such tests, the number of combinations of input parameters can grow exponentially. For example, with 10 optional parameters, the number of combinations can reach 1024.

In actual software testing tasks, it is exceedingly impractical to manually create test cases to address all the above scenarios, given the large number of test cases. It is also difficult to create new test cases by random generation to ensure the pertinence and effectiveness of the test. Taking fuzzy testing as an example, it explores program behavior by generating random inputs. In a product development stage, after comprehensive functional testing, most common errors have been fixed, which reduces the probability of encountering unexpected behaviors in fuzzy testing and prolongs the cycle of discovering new problems. In addition, in most practical scenarios, checking code coverage is difficult. For large software products with millions of lines of code, it is almost unrealistic to check the code coverage for each test case one by one. Single analysis of code coverage is highly time-consuming, and even if it can be completed, the efficiency is very low. Therefore, in order to improve testing efficiency, it is necessary to filter out significant test cases and add them to a test case library as input for software testing.

Regarding this, embodiments of the present disclosure provide a solution for updating a test case library. In an embodiment of the present disclosure, a test case library has a feature representation library corresponding thereto. Before adding one or a batch of candidate test cases to the test case library, feature representation of the candidate test cases can be extracted by means of a language model. A similarity between the feature representation of the candidate test cases and each feature representation in a feature representation library can also be calculated respectively. Then, based on these similarities, it can be determined whether to add the candidate test case to a database. Therefore, when updating the test case library, the candidate test cases with low similarity to existing test cases can be selected and added to the test case library, and the candidate test cases with high similarity to existing test cases are discarded.

In this way, candidate test cases with low similarity to existing test cases can be selected as significant test cases and added to the test case library, thereby improving the diversity of the test case library and reducing the situation where the test time is unnecessarily extended due to the overly high similarity of test cases.

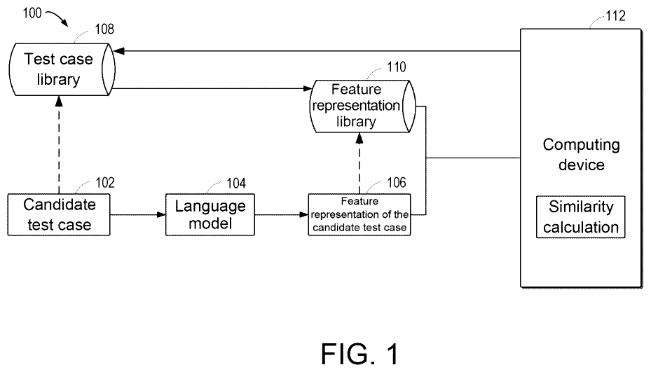

FIG. 1 is a schematic diagram of an example environment 100 in which a plurality of embodiments of the present disclosure can be implemented. FIG. 1 may include a candidate test case 102, a language model 104, feature representation 106 of a candidate test case, a test case library 108, a feature representation library 110, and a computing device 112. It should be understood that the types and numbers of models, data transmission processes, arrangements, etc. shown in FIG. 1 are only exemplary. The example environment 100 may include different numbers of models, data transmission processes, various additional elements, etc. in different arrangements

As shown in FIG. 1, in the example environment 100, the language model 104 can be used to extract the candidate test case 102 to obtain the feature representation 106 of the candidate test case. For example, the language model 104 can be used to encode the candidate test case 102 into a feature vector.

As shown in FIG. 1, in the example environment 100, the feature representation library 110 is obtained by operating test cases in the test case library 108. For example, each test case in the test case library 108 is respectively input to the language model 104, a feature representation is extracted, and the feature representation is stored into a database so as to obtain a feature representation library 110.

As shown in FIG. 1, in the example environment 100, calculation of a similarity between the feature representation 106 of the candidate test case and the feature representation library 110 is performed based on the computing device 112. In addition, the computing device 112 can feed a result of the similarity calculation back to the test case library 108 for determining whether to add the candidate test case 102 to the test case library 108. In addition, for the candidate test case 102 added to the test case library 108, the feature representation 106 of the candidate test case can be added to the feature representation library 110.

In the example environment 100, the feature representation can be rapidly extracted by means of the language model 104, calculation of the similarity between feature representation 106 of the candidate test case and the feature representation in the feature representation library 110 can be performed by the computing device 112, and it is determined, based on the similarity, whether to add the candidate test case 102 to the test case library 108. In this way, candidate test cases with low similarity to existing test cases can be quickly filtered out and added to the test case library, improving the diversity of test cases and enhancing testing efficiency.

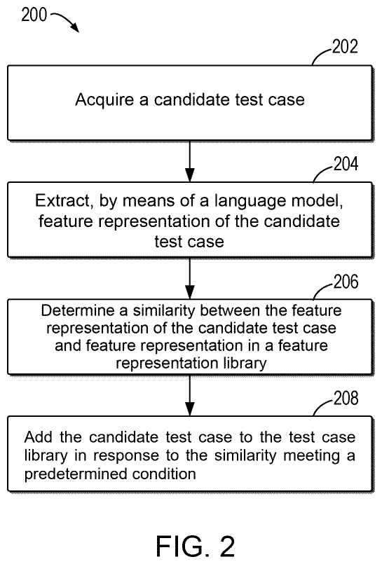

FIG. 2 shows a flow chart of a method 200 for updating a test case library based on a language model according to some embodiments of the present disclosure. The test case library 108 as shown in FIG. 1 can be updated with the method in FIG. 2. As shown in FIG. 2, at block 202, the method 200 includes acquiring a candidate test case to be added to the test case library. The candidate test case can be obtained by performing mutation on a test case in the test case library, or it can be directly generated through manual design or automated tools. The method 200 does not limit this.

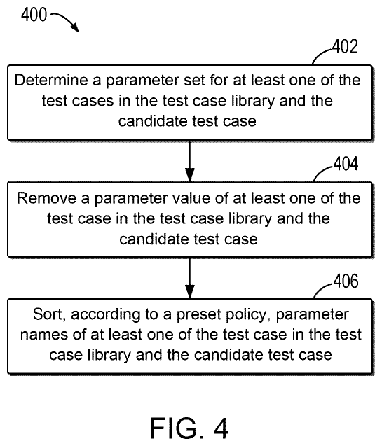

At block 204, the feature representation of the candidate test case is extracted by means of the language model. In some embodiments, before the language model needs to be input, preprocessing operations are performed on the candidate test case according to a unified procedure, and the exemplary preprocessing method will be explained in detail in the description of FIG. 4.

At block 206, a similarity between the feature representation of the candidate test case and one or more feature representations of the feature representation library is determined. In some embodiments, the feature representation library is obtained by processing the test cases in the test case library, and feature representations in the feature representation library are one-to-one corresponding to the test cases in the test case library.

At block 208, the candidate test case is added to the test case library in response to the similarity meeting a predetermined condition. It should be noted that the candidate test case can be selected from a candidate set. In this case, it can be determined whether multiple candidate test cases from the same batch in the candidate set meet the predetermined condition, and the candidate test cases in the candidate set with similarity that meets the predetermined condition can be uniformly added to the test case library.

In this way, the method 200 can filter out candidate test cases with low similarity to existing test cases and add them to the test case library as significant test cases, thereby improving the diversity of the test case library and improving the efficiency of software testing.

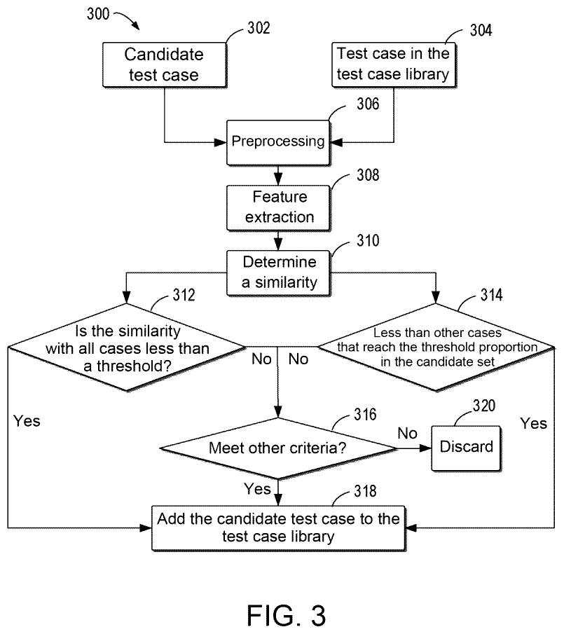

FIG. 3 shows a flow chart of a method 300 for determining whether to add candidate test cases to a test case library according to some embodiments of the present disclosure. As shown in FIG. 3, a candidate test case 302 and a test case 304 in the test case library are input to block 306 for preprocessing. Block 306 can perform preprocessing on the input test cases according to a uniform standard. The preprocessing method according to some embodiments of the present disclosure will be described below with reference to FIG. 4. FIG. 4 shows a flow chart of a preprocessing method 400 according to some embodiments of the present disclosure.

At block 402, the preprocessing method 400 includes taking at least one of the test cases in the test case library and the candidate test case as a test case to be processed, and determining a parameter set for each to-be-processed test case. In some embodiments, the parameter set for each to-be-processed test case includes at least one parameter, and data corresponding to each parameter belongs to key value pair data, where the key in the key value pair corresponds to a parameter name and the value in the key value pair corresponds to a parameter value of the parameter.

In software testing, changing the parameter value of the test case from a random character string to another character string will not affect the result in most cases. (Only when the change reaches a boundary condition, such as when the character string length exceeds the range, will it affect the result. However, such situations are usually covered by functional testing). At block 404, the preprocessing method 400 includes removing a parameter value of each to-be-processed test case. For example, for the following exemplary test case:

```
{
  name: test_su
  user: admin
  tenant_id: 1
  quota_config:
    {
      hard_limit: 2048
      soft_limit: 1024
    }
  ...
}
```

After removing the parameter value, the following test case containing only the parameter name will be obtained:

```
{
  name
  user
  tenant_id:
  quota_config:
    {
      hard_limit
      soft_limit
    }
  ...
}
```

With the above method, the preprocessing method 400 ensures that the feature extraction process of the test case through the language model is not affected by the parameter value of the test case, so as to avoid the influence of parameter value differences on the similarity evaluation between the candidate test case and the existing test cases in the library, further ensuring the diversity of the test case library.

Changing the order of internal parameter names for a test case will not have any impact on the test results. At block 406, the preprocessing method 400 includes sorting multiple parameter names in the test case processed by block 404 according to a unified preset sorting strategy. In some embodiments, the sorting strategy can be sorting in ascending or descending order according to the alphabetical order of these parameter names. The present disclosure does not limit the specific sorting strategy, as long as it can sort the multiple parameter names in all test cases according to a unified standard. With the above method, the preprocessing method 400 can avoid repeatedly adding the test cases with the same parameter names (the only difference being the internal sorting of parameter names) to the test case library, thereby further ensuring the diversity of the test case library.

Returning to FIG. 3, at block 308, the method 300 includes extracting features from at least one of the candidate test case and the test case in the test case library that have been preprocessed using the language model 104 (such as a sentence transformer) in example environment 100. In some embodiments, the method 300 includes converting the test cases in the test case library 108 (such as a seed corpus) into feature representation (such as vectors) using the language model 104 in example environment 100, and generates a feature representation library (such as storing the feature representation into a vector library such as Fuss).

At block 310, the method 300 can include calculating a similarity between the feature representation of the candidate test case and the existing test cases in the library using the computing device 112 of example environment 100. In some embodiments, the feature representation can be a vector, and the similarity between the candidate test case and the existing test cases in the library can be achieved by calculating a cosine similarity of the corresponding vectors. For example, for a vector a and a vector b, the formula for calculating the cosine similarity is as follows:

a*b/|a|/|b|

In this case, the cosine similarity is a floating-point number ranging from 0 to 1.

At block 312, the similarity between the feature representation of the candidate test case 302 and each feature representation in the feature representation library is compared with a unified preset threshold. In response to the similarity between the feature representation of the candidate test case and each feature representation in the feature representation library being less than the preset threshold, proceed to block 318 and add the candidate test case 302 to the test case library; otherwise, proceed to block 316 to determine if the candidate test case 302 meets other criteria. In some embodiments, the preset threshold can be dynamically adjusted based on the requirements of actual testing tasks. For example, when the testing tasks require high efficiency, a small preset threshold can be selected to reduce the number of candidate test cases added to the test case library and ensure that the candidate test cases added to the test case library have a low similarity with the existing test cases in the library.

Alternatively or additionally, at block 314, the candidate test case 302 is selected from the candidate set. The similarity corresponding to the candidate test case 302 is compared with the similarity corresponding to other test cases in the candidate set. In response to the similarity corresponding to the candidate test case 302 being less than the similarity corresponding to other test cases in the candidate set whose proportion reaches the preset threshold, proceed to block 318 and add the candidate test case 302 to the test case library; otherwise, proceed to block 316 and determine if the candidate test case 302 meets other criteria. In some embodiments, the similarity between a candidate test case and each test case in the test case library is respectively calculated, and a maximum value is selected therefrom as the similarity corresponding to the candidate test case and compared with the similarity corresponding to other test cases in the candidate set. In some embodiments, the preset threshold can be dynamically adjusted based on the needs of actual testing tasks. If more test cases are needed to ensure comprehensive testing, the preset threshold can be lowered so that more test cases in the candidate set can meet the condition and are added to the test case library. In some embodiments, after uniformly performing preprocessing (block 306), feature extraction (block 308), and similarity determination (block 301) on all the test cases in the candidate set, some corresponding candidate test cases with the smallest similarity in the candidate set (e.g., the test cases ranked in the bottom 20% of similarity values) are selected and added to the test case library.

At block 316, it is determined whether the candidate test case that is not added to the test case library in the above steps meets any of the other criteria (such as program errors caused by the candidate test case, overwriting new scenarios, etc.). In response to the candidate test case meeting any of the other criteria, add the candidate test case to the test case library. In response to the candidate test case not meeting all the other criteria, proceed to block 320 and discard the candidate test case. It should be noted that in some embodiments, block 316 can be executed independently of other steps in the present disclosure, that is, when the candidate test case meets other criteria (such as causing program errors), there is no need to execute other steps in the present disclosure, directly proceed to block 318 and add the candidate test case to the test case library. In some other embodiments, the process shown in block 316 can be omitted. In this case, if the candidate test case does not meet the determining conditions of blocks 312 and 314, proceed directly to block 320 and discard the candidate test case.

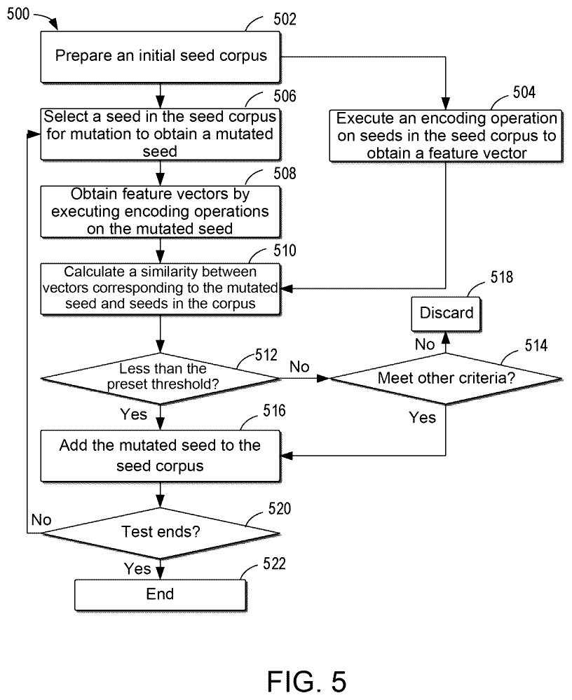

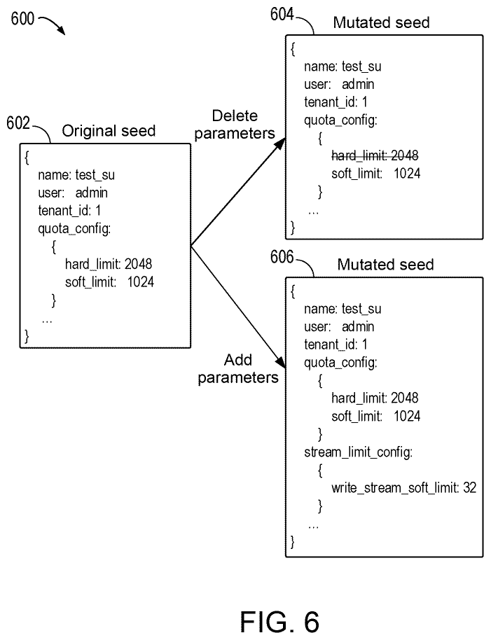

At block 318, the method 300 includes adding the candidate test case to the test case library. In some embodiments, when the candidate test case is added to the test case library, the feature representation corresponding to the candidate test case will also be correspondingly added to the feature representation library, so as to dynamically update the similarity determining criteria for subsequent candidate test cases to ensure diversity of all test cases in the test case library. FIG. 5 shows a flow chart of a method 500 for updating a seed corpus of fuzzy testing according to some embodiments of the present disclosure. In fuzz testing, a test case is randomly generated, and compared with other testing methods, fuzz testing requires a significant amount of time to detect program issues. In the method 500, the seed corpus is used as an example of the test case library, and a mutated seed is used as an example of the candidate test case. By determining the similarity between a newly generated mutated seed and existing seeds in the seed corpus in real time during the fuzz testing process, a seed with low similarity is added to the seed corpus to enhance its diversity and reduce the time required for fuzz testing. As shown in FIG. 5, at block 502, the method 500 includes preparing an initial seed corpus. In some embodiments, the seed corpus can be prepared using existing methods in fuzz testing, for example, the original seed 602 in FIG. 6 is an example seed that creates storage units in a data domain.

At block 504, feature vectors are obtained by executing encoding operations on seeds in the seed corpus by means of a language model. In some embodiments, before performing encoding operations, a unified preprocessing operation can be performed on the seeds in the seed corpus. For example, according to the preprocessing method 400 shown in FIG. 4, a parameter set for each seed in the seed corpus can be determined separately. The parameter set for each seed includes at least one parameter, and the data corresponding to each parameter belongs to the key value pair data. The key in the key value pair corresponds to the parameter name, and the value in the key value pair corresponds to the parameter value of the parameter. The parameter value of each seed in the seed corpus can also be removed.

For example, in fuzz testing, the change in parameter value is not sufficient to make a mutated seed have a significance. For example, for string parameters such as file names, changing the value of the file name from a random character string to another character string will not cause any changes to the test result in most cases. Although changes in the parameter value that reach boundary conditions, for example, when the character string length exceeds the range, will affect the test result, such testing is usually included in the boundary value testing of functional testing and is not the main task of fuzz testing. With the above method, it is ensured that the selection of the mutated seed is not affected by changes in the parameter value.

For a seed with a parameter value removed, different parameters in the seed are sorted according to a unified preset sorting strategy to obtain the preprocessed seed. In some embodiments, different parameter names in a seed are sorted in ascending or descending order according to a parameter name alphabet table.

In some embodiments, feature vectors obtained from block 504 are stored in a vector library such as Fuss, thereby obtaining the vector library corresponding to the seed corpus. In some embodiments, the vectors of newly added seed in the seed corpus are stored in real time into the vector library to achieve dynamic updates.

At block 506, a seed in the seed corpus is selected for mutation to obtain a mutated seed. In some embodiments, mutation is performed on the seed through one or more operations such as adding a seed parameter, deleting a seed parameter, or changing a seed parameter. Performing a mutation method 600 on a fuzz testing seed according to some embodiments of the present disclosure will be described with reference to FIG. 6. According to some embodiments of the present disclosure, in the mutation method 600, a mutated seed 604 can be obtained by deleting a parameter (such as deleting hard_limit: 2048 in an original seed 602) or a mutated seed 606 can be obtained by adding a parameter (such as adding stream_limit_config: {write_stream_soft_limit: 32} to the original seed 602).

At block 508, an encoding operation is executed on the mutated seed by means of a language model to obtain a vector corresponding to the mutated seed. In some embodiments, before executing the encoding operation, preprocessing is uniformly executed on the mutated seed and seeds in the seed corpus according to the above preprocessing method 400. In some embodiments, encoding operations are uniformly executed on the mutated seed and seeds in the seed corpus by means of the same language model.

At block 510, the similarity between the vectors corresponding to the mutated seed and seeds in the corpus is calculated. In some embodiments, a cosine similarity between vectors corresponding to the mutated seed and seeds in the corpus is calculated; for example, for the vector a (1, 0, 1) and a vector b (1, 1, 0), the cosine similarity is 0.5. In some embodiments, one or more methods, including but not limited to graphics processing unit (GPU) acceleration schemes, multi-core central processing unit (CPU) parallel schemes, distributed computing schemes, etc., can be used to accelerate the calculation of vector similarity.

At block 512, it is determined whether the similarity between vectors corresponding to the mutated seed and seeds in the corpus is less than a preset threshold. In some embodiments, if the similarity between the mutated seed and all seeds in the corpus is below the threshold (such as 0.7), the mutated seed is considered to have a significance and added to the seed corpus. In some other embodiments, the similarities between multiple mutated seeds and all seeds in the corpus are calculated respectively. If a similarity corresponding to a mutated seed is less than that of other mutated seeds that reach a certain percentage (e.g., 80%), the mutated seed is considered to have a significance and added to the seed corpus.

If the similarity between the vector corresponding to the mutated seed and the vectors corresponding to seeds in the corpus is less than the preset threshold, proceed to block 516 and add the mutated seed to the seed corpus, otherwise, proceed to block 514 and determine whether the mutated seed meets other criteria. If the mutated seed meets other criteria (block 514), proceed to block 516 and add the mutated seed to the seed corpus, otherwise, proceed to block 518 and discard the mutated seed. It should be noted that in some embodiments, block 514 can be executed independently of other steps in the present disclosure, that is, when the candidate test case meets other criteria (such as causing program errors or overwriting new scenarios), the candidate test case can be directly added to the test case library without executing other steps in the present disclosure. In some other embodiments, the process shown in block 514 can be omitted.

In some embodiments, if the mutated seed is added to the seed corpus, its corresponding vector is correspondingly added to the vector library, so as to use the newly added seed as the benchmark for determining the similarity of subsequent seeds. For example, the seed corpus contains N original seeds, and the vector library contains N vectors one-to-one corresponding to the original seeds. If the similarity between the newly generated mutated seed and the other N original seeds meets a threshold condition, the newly generated mutated seed will be added to the seed corpus and its corresponding vector will be added to the vector library. For the next mutated seed, it is necessary to determine the similarity between its corresponding vector and N+1 vectors in the vector library. In this way, the method 500 can reduce the similarity between multiple mutated seeds added to the seed corpus.

At block 520, it is determined whether fuzz testing is completed. If the fuzz testing has not been completed, the method 500 can return from block 520 to block 506 to regenerate a mutated seed, so as to continue generating the mutated seed during the fuzz testing process and determine whether to add it to the seed corpus. If the fuzz testing is completed, proceed to block 522 and end the process of the method 500.

With the method, a similarity between a mutated seed and existing seeds in a seed corpus can be determined, so as to find the mutated seed with low similarity to the existing seeds by comparing the similarity with the preset threshold and add it to the seed corpus. Therefore, it is possible to ensure that the seeds in the corpus have diversity and avoid blindly adding the mutated seeds, which can lead to low efficiency in fuzz testing.

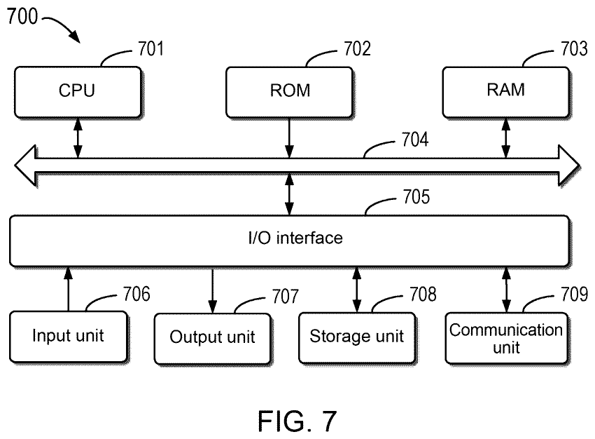

FIG. 7 shows a block diagram of an example device 700 which can be used to implement embodiments of the present disclosure. As shown in the figure, the device 700 comprises a computing unit 701, illustratively implemented as at least one CPU, that may perform various appropriate actions and processing according to computer program instructions stored in a read-only memory (ROM) 702 or computer program instructions loaded from a storage unit 708 to a random access memory (RAM) 703. Various programs and data required for the operation of the device 700 may also be stored in the RAM 703. The computing unit 701, the ROM 702, and the RAM 703 are connected to each other via a bus 704. An input/output (I/O) interface 705 is also connected to the bus 704.

Multiple components in device 700 are connected to an I/O interface 705, including: an input unit 706, such as a keyboard and a mouse; an output unit 707, such as various types of displays and speakers; the storage unit 708, such as a magnetic disk and an optical disk; and a communication unit 709, such as a network card, a modem, and a wireless communication transceiver. The communication unit 709 allows the device 700 to exchange information/data with other devices via a computer network, such as the Internet, and/or various telecommunication networks.

The computing unit 701 may be various general-purpose and/or special-purpose processing components with processing and computing powers. Some examples of the computing unit 701 include, but are not limited to, the above-noted CPUs and/or GPUs, various specialized artificial intelligence (AI) computing chips, various computing units for running machine learning model algorithms, digital signal processors (DSPs), and any appropriate processors, controllers, microcontrollers, etc. The computing unit 701 performs various methods and processes described above, such as the method 200. For example, in some embodiments, the method 200 may be implemented as a computer software program that is tangibly included in a machine-readable medium, such as the storage unit 708. In some embodiments, part or all of the computer program may be loaded and/or installed onto the device 700 via the ROM 702 and/or the communication unit 709. When the computer program is loaded to the RAM 703 and executed by the computing unit 701, one or more steps of the method 200 described above may be performed. Alternatively, in other embodiments, the computing unit 701 may be configured to implement the method 200 in any other suitable manner (such as by means of firmware).

The functions described herein can be performed at least in part by one or more hardware logic components. For example, non-restrictively, demonstration types of hardware logic components that can be used include Field Programmable Gate Arrays (FPGAs), Application Specific Integrated Circuits (ASICs), Application Specific Standard Products (ASSPs), Systems On Chip (SOC), Complex Programmable Logic Devices (CPLDs), etc.

Program code for implementing the method of the present disclosure may be written by using one programming language or any combination of multiple programming languages. The program code may be provided to a processor or controller of a general purpose computer, a special purpose computer, or another programmable data processing apparatus, such that the program code, when executed by the processor or controller, cause the functions/operations specified in the flow charts and/or block diagrams to be implemented. The program code may be executed completely on a machine, executed partially on a machine, executed partially on a machine and partially on a remote machine as a stand-alone software package, or executed completely on a remote machine or server.

In the context of the present disclosure, a machine-readable medium may be a tangible medium that may include or store a program for use by an instruction execution system, apparatus, or device or in connection with the instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include one or more wire-based electrical connections, a portable computer diskette, a hard disk, a RAM, a ROM, an erasable programmable read-only memory (EPROM or flash memory), an optical fiber, a portable compact disc read-only memory (CD-ROM), an optical storage device, a magnetic storage device, or any suitable combination thereof. Additionally, although operations are depicted in a particular order, this should not be construed as an indication that such operations are required to be performed in the particular order shown or in a sequential order, or that all illustrated operations should be performed to achieve desirable results. In certain environments, multitasking and parallel processing may be advantageous. Likewise, although the above discussion contains several specific implementation details, these should not be construed as limitations to the scope of the present disclosure. Certain features that are described in the context of separate embodiments may also be implemented in combination in a single implementation. In contrast, various features that are described in the context of a single implementation may also be implemented in multiple implementations separately or in any suitable sub-combination.

Although the present subject matter has been described using a language specific to structural features and/or method logical actions, it should be understood that the subject matter defined in the appended claims is not necessarily limited to the particular features or actions described above. Rather, the specific features and actions described above are merely example forms of implementing the claims.

What is claimed is:

1. A method for updating a test case library, comprising:
acquiring a candidate test case;
extracting, by means of a language model, a feature representation of the candidate test case;
determining a similarity between the feature representation of the candidate test case and one or more feature representations in a feature representation library corresponding to the test case library; and
adding the candidate test case to the test case library in response to the similarity meeting a predetermined condition.

2. The method according to claim 1, further comprising:
extracting, by means of the language model, a feature representation of each test case in the test case library to generate the feature representation library corresponding to the test case library.

3. The method according to claim 2, further comprising:
determining a parameter set for at least one of a plurality of test cases in the test case library and the candidate test case, wherein the parameter set comprises at least one parameter, and data corresponding to each parameter belongs to key value pair data; a key in the key value pair data corresponds to a parameter name of the parameter, and a value in the key value pair data corresponds to a parameter value of the parameter;
removing, according to the parameter set, a parameter value of at least one of the test cases in the test case library and the candidate test case, to obtain a test case containing parameter names that is at least one of the test cases in the test case library and the candidate test case; and
sorting, according to a preset sorting policy, parameter names of at least one of the test cases in the test case library and the candidate test case, to obtain at least one of the test cases in the test case library and the candidate test case that have been preprocessed.

4. The method according to claim 1, wherein the test case library is a seed corpus used for fuzz testing, and the candidate test case is a candidate seed used for fuzz testing.

5. The method according to claim 4, wherein acquiring the candidate test case comprises executing a mutation operation on a seed in the seed corpus by one or more of the following operations:
adding parameters of the seed;
deleting parameters of the seed; and
changing parameters of the seed.

6. The method according to claim 4, wherein the feature representation of the candidate seed is a vector, the feature representation library is a vector library, and determining a similarity between the vector of the candidate seed and a vector of the vector library comprises:
determining a cosine similarity between the vector of the candidate seed and the vector of the vector library.

7. The method according to claim 1, wherein adding the candidate test case to the test case library in response to the similarity meeting a predetermined condition comprises:
in response to a similarity between the feature representation of the candidate test case and each feature representation in the feature representation library being less than a preset threshold, adding the candidate test case to the test case library.

8. The method according to claim 1, wherein the candidate test case is selected from a candidate set, and adding the candidate test case to the test case library in response to the similarity meeting a predetermined condition comprises:
in response to the similarity corresponding to the candidate test case being less than the similarity corresponding to other test cases in the candidate set that have proportions reaching a preset threshold, adding the candidate test case to the test case library.

9. The method according to claim 1, further comprising:
in response to the candidate test case leading to program errors, adding the candidate test case to the test case library.

10. The method according to claim 1, further comprising:
in response to the similarity meeting a predetermined condition, adding the feature representation of the candidate test case to the feature representation library.

11. An electronic device, comprising:
at least one processor; and
memory coupled to the at least one processor and having instructions stored therein, wherein the instructions, when executed by the at least one processor, cause the electronic device to perform actions comprising:
acquiring a candidate test case;
extracting, by means of a language model, a feature representation of the candidate test case;
determining a similarity between the feature representation of the candidate test case and one or more feature representations in a feature representation library corresponding to a test case library; and
adding the candidate test case to the test case library in response to the similarity meeting a predetermined condition.

12. The electronic device according to claim 11, wherein the actions further comprise:
extracting, by means of the language model, a feature representation of each test case in the test case library to generate the feature representation library corresponding to the test case library.

13. The electronic device according to claim 12, wherein the actions further comprise:
determining a parameter set for at least one of a plurality of test cases in the test case library and the candidate test case, wherein the parameter set comprises at least one parameter and data corresponding to each parameter belongs to key value pair data; a key in the key value pair data corresponds to a parameter name of the parameter, and a value in the key value pair data corresponds to a parameter value of the parameter.
removing, according to the parameter set, a parameter value of at least one of the test cases in the test case library and the candidate test case to obtain a test case containing parameter names that is at least one of the test cases in the test case library and the candidate test case; and
sorting, according to a preset sorting policy, parameter names of at least one of the test cases in the test case library and the candidate test case, to obtain at least one of the test cases in the test case library and the candidate test case that have been preprocessed.

14. The electronic device according to claim 11, wherein the test case library is a seed corpus used for fuzz testing, and the candidate test case is a candidate seed used for fuzz testing.

15. The electronic device according to claim 14, wherein acquiring the candidate test case comprises executing a mutation operation on a seed in the seed corpus by one or more of the following operations:
adding parameters of the seed;
deleting parameters of the seed; and
changing parameters of the seed.

16. The electronic device according to claim 14, wherein the feature representation of the candidate seed is a vector, the feature representation library is a vector library, and determining a similarity between the vector of the candidate seed and a vector of the vector library comprises:
determining a cosine similarity between the vector of the candidate seed and the vector of the vector library.

17. The electronic device according to claim 11, wherein adding the candidate test case to the test case library in response to the similarity meeting a predetermined condition comprises:
in response to a similarity between the feature representation of the candidate test case and each feature representation in the feature representation library being less than a preset threshold, adding the candidate test case to the test case library.

18. The electronic device according to claim 11, wherein the candidate test case is selected from a candidate set, and adding the candidate test case to the test case library in response to the similarity meeting a predetermined condition comprises:
in response to the similarity corresponding to the candidate test case being less than the similarity corresponding to other test cases in the candidate set that have proportions reaching a preset threshold, adding the candidate test case to the test case library.

19. The electronic device according to claim 11, wherein the actions further comprise:
in response to the similarity meeting a predetermined condition, adding the feature representation of the candidate test case to the feature representation library.

20. A computer program product comprising a non-transitory computer-readable medium having machine-executable instructions stored therein, wherein the machine-executable instructions, when executed by a machine, cause the machine to perform actions comprising:
acquiring a candidate test case;
extracting, by means of a language model, a feature representation of the candidate test case;
determining a similarity between the feature representation of the candidate test case and one or more feature representations in a feature representation library corresponding to a test case library; and
adding the candidate test case to the test case library in response to the similarity meeting a predetermined condition.
